(19) United States
(12) Patent Application Publication
(10) Pub. No.: US 2017/0051976 A1
(43) Pub. Date: Feb. 23, 2017

(54) METHOD AND DEVICE FOR DRYING WOOD CHIPS

(71) Applicant: Gaston GLOCK, Velden (AT)

(72) Inventor: Gaston GLOCK, Velden (AT)

(21) Appl. No.: 15/233,074

(22) Filed: Aug. 10, 2016

(30) Foreign Application Priority Data
Aug. 18, 2015 (AT) A546/2015

(51) Int. Cl. F26B 23/02; F23K 1/04

(52) U.S. Cl. CPC F26B 23/028; F23K 1/04

(57) ABSTRACT

A method and device for drying wood chips to be used as raw material for a gas-generating reactor, the device being disposed between the storage for wood chips and the reactor. Product gas of the reactor is at least partially used in a block-type thermal power station (BHKW), and hot air from the housing of the block-type thermal power station is used to heat and dry wood chips in a drying hopper which has at least one outlet for the cooled humidified air. The wood chips enter the drying hopper through a first air-tight lock and exit the drying hopper through a second air-tight lock.

The invention relates to a method and to a device for drying wood chips, according to the preamble of claim 1 and of claim 4, said wood chips being the raw material for a gas generator (reactor) as is described in the as yet not published EP 15158828.8 of the same applicant and operated in conjunction with a block-type thermal power station. The wood chips which are infed to a wood gasification reactor of this type should have a moisture content of maximum 15% in percentage by weight in relation to the dry weight of the wood chips.

Since “raw” wood chips usually have a moisture content of between 35 and 50% of weight, said wood chips in the prior art are dried in special dryers, mostly using energy which is procured independently of the energy flow of the later use of the wood chips (external energy), and then temporarily stored in one or else a plurality of hoppers. Said wood chips by way of storage again absorb moisture from the ambient air, this having to be considered in the context of the degree of drying. The dryers and the hoppers require space, tie up capital, and require maintenance.

Despite the large amount of heat released in the reactor, drying wood during introduction into the reactor or thereafter is not possible since the required evaporation heat lowers the temperature that is reached in the reactor to such an extent that the temperature required for the generation of synthetic gas according to the Boudouard equilibrium is no longer attained.

Literature which concerns thermal transfer in various plants and to some extent drying of primary materials and which may be cited include U.S. 2013/257 059 (compact plant for the gasification of biomass for producing electricity), DE 43 08 522 (heating air for indirect heating of drying plants with air), WO 03/042 520 (drying using residual heat of exhaust gases), EP 2 341 229 (utilization of turbine exhaust gas for drying fuel), EP 2 902 738 (ditto) and DE 10 2014 009 351 (utilization of exhaust heat in the form of radiation energy thereof). All these devices and methods require complex apparatuses and interfere with the respective reactor processes, leading to complex consequences with secondary effects which are often uncontrollable. Moreover, handling and manipulating exhaust gases which ultimately are toxic and contain pollutants is precarious at all times and in the case of a secondary utilization of this type makes subsequent cleaning, which is often prescribed and should always be considered desirable, complicated and complex.

It is an object of the invention to provide method management which is simpler and more cost-effective, and corresponding cost-effective, robust equipment in terms of plant technology.

According to the invention, this is implemented by a method and by a device, respectively, having the features which are stated in the characterizing parts of the independent claims. In other words, the method, in a lower region in a hopper which is as directly upstream of the reactor as possible, is based on infeeding exhaust air from the block-type thermal power station to the raw material which in this hopper, depending on the amount being infed to the reactor per unit of time, moves from the top to the bottom, and on directing said air in a counter flow toward the top of the hopper. Additionally, but above all for starting up, it may be provided that air heated by external energy by way of a heat exchanger is blown in. The respective embodiment in terms of plant technology provides according to the invention for a hopper, when viewed in the direction of the method sequence, to be disposed as directly as possible ahead of the reactor, in terms of plant technology preferably above the hopper, and for the exhaust air of the block-type thermal power station, at least partially controlled by a respective regulator element, to be introduced in a suitable amount into the lower region of the hopper and for said air to be extracted in the upper region of said hopper. The raw material stream is preferably infed to the hopper and removed therefrom, respectively, by locks that are as gas-tight as possible, preferably by rotary-valve type locks, or the like.

The (at least predominantly) used energy is thus supplied by the exhaust heat and from the radiation losses of the engine block which arises in the encapsulation thereof or the housing in which said engine block is accommodated, respectively; said energy is thus quasi “free of charge”. Due to the method management according to the invention, the dried comminuted product no longer comes into contact with the ambient air and thus does not absorb more moisture. The costly drying bases and intermediate hoppers can be completely dispensed with.

The invention will be explained in more detail hereunder by means of the drawing in which:

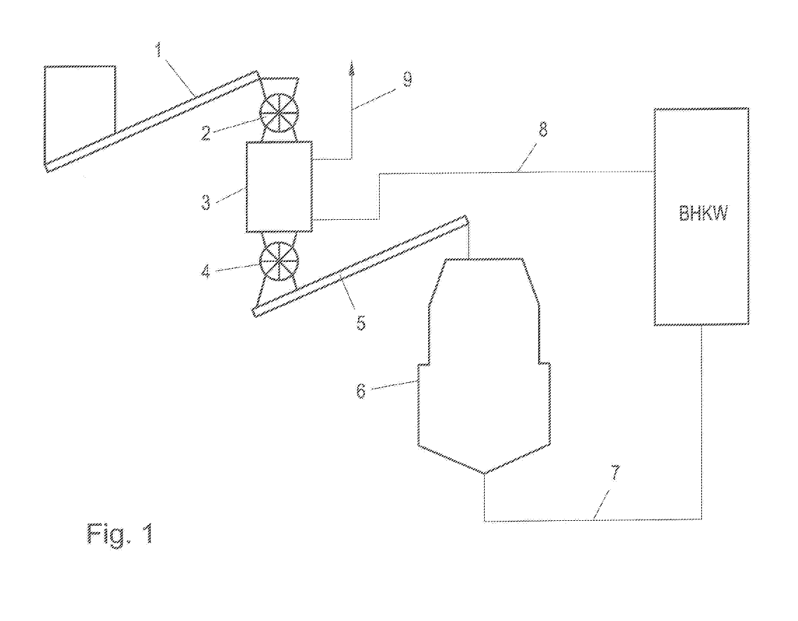

FIG. 1 very schematically shows a flow diagram according to the invention; and

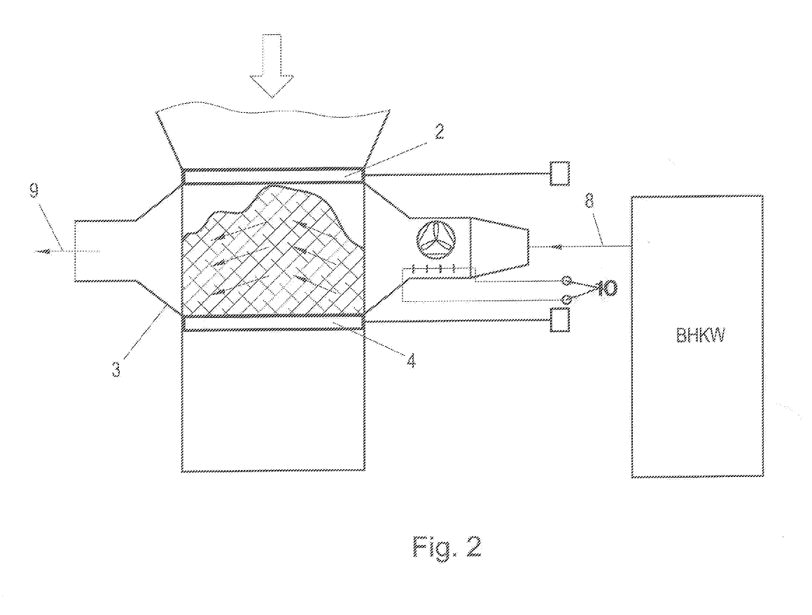

FIG. 2 schematically shows an arrangement of the individual components.

As can be seen from FIG. 1, the raw material to be gasified, that is to say wood in chip form, from a pile, a tank, or a hopper, etc., by way of a conveying line 1 reaches a gas-tight lock 2, for example a rotary-valve type lock. From there, the raw material drops or slides into a drying hopper 3 at the lower end of which said raw material is removed, again by way of a gas-tight lock 4, and optionally by way of an intermediate line 5 reaches the reactor 6 per se.

The reactor 6 in various embodiments is known from the prior art and at this point, in order to avoid digressions, is therefore not explained in more detail. It should only be stated that at least one product gas line 7 leads out of the reactor 6 (in the illustration in a purely schematic manner leading out of the base but in many cases leading out of a region thereabove), in which the product gas is transported for further use. This use presently includes at least one block-type thermal power station (BHKW).

According to experience a temperature which is significantly higher than in the surroundings or even in the building, in the case of a stationary block-type thermal power station, prevails due to the heat radiation in the building in which the block-type thermal power station is accommodated, said building colloquially often being used interchangeably with the term block-type thermal power station. According to the invention, a regulatable hot air line 8 leads from the block-type thermal power station, preferably from the roof region or the ceiling region thereof, respectively, in which hot air accumulates, to the lower region of the drying hopper 3, there opening in one or preferably a plurality of nozzle-type openings into the interior. This infed hot air heated by the heat radiation in the block-type thermal power station, which here serves for drying the incoming raw material and which also heats the latter in a counter flow, now charged with humidity is discharged in the upper region of the drying hopper 3 by way of one or preferably a plurality of removal openings, and then is discharged by way of a ring line or the like, and by way of an exhaust air line 9. This cooled air which is charged with humidity is harmless and, following optional filtration, is vented to the environment.

It can be achieved by this type of drying that operational conditions which are particularly favorable and advantageous for wood gasification can be readily and permanently maintained in the reactor 6. It has been found to be particularly advantageous that the drying hopper 3, in which drying takes place, and the reactor 6 in spatial terms are disposed close to one another such that the material, that is to say the raw material or the wood chips, reaching the reactor is not only dry, as has already been targeted in the past, but that due to the proximity moreover thermal energy in the form of heating which is equal to pre-heating is returned to the reactor. With reference to purely schematic FIG. 1 this means that the lock 4 instead of the intermediate line 5 is placed directly at the head of the reactor 6. In this way, the energy required for reaching the favorable side of the Boudouard equilibrium is obtained in a particularly favorable manner.

It has furthermore been found that this is at least substantially also possible by employing external energy if and when, as already mentioned, also the spatial proximity and also heating and drying of the raw material which will reach the reactor (convertor) in the closest possible future is always ensured in this instance, this being the most important factor as the energy employed for drying is returned thereby to the largest possible extent to the reactor, the thermal losses thus being able to be minimized.

Providing preferably only additional heating by external energy may be expedient for the starting-up procedure of the wood gasification and for extreme operational situations. Herein, instead of or additionally to the ambient air of the block-type thermal power station, air (ambient air, exhaust air from buildings, etc.) is heated in heat exchangers using external energy and blown through the drying bunker, preferably from the bottom to the top. This design embodiment or starting aid, respectively, is not illustrated in FIG. 1.

FIG. 2, on the one hand, purely schematically shows the external heating 10 as has been explained above and, on the other hand, a variant to the extent that the heated air from the block-type thermal power station and/or from an external heating, is blown in a substantially horizontal manner and thus in a cross flow through the drying hopper 3. Slides or rotary slides, respectively, are indicated as locks 2, 4; the configuration of the inflow nozzles or of the outlet openings, respectively, is readily implementable by a person skilled in the art and with knowledge of the invention. An arrangement of this type in the case of different installation situations may better utilize the available space; the thermal and process-technological dissimilarities can be readily judged and considered by a person skilled in the art and with knowledge of the invention.

That as good as possible thermal insulation of the drying hopper and placement thereof in the shed should be performed at a location which is as warm as possible and as close as possible to the reactor when carrying out a process of this type will not be further surprising to a person skilled in the art, based on the narrative to date. It should be furthermore pointed out that in the description and in the claims statements such as “largely” in the case of materials mean in excess of 50% in weight, preferably in excess of 80% in weight, and particularly preferably in excess of 95% in weight; that “lower region” of a reactor, a filter, a building, or a device, or very generally of an item means the lower half and in particular the lower quarter of the total height, “lowermost region” means the lowermost quarter and in particular an even smaller part; while “central region” means the central third of the total height. All these statements, likewise “top”, “bottom”, “front”, “rear”, etc. have their common meaning applied to the respective item in the position according to the intended use.

“Substantially” in the description and in the claims may be delimited using a deviation of 10% of the stated value to the higher and to the lower side, if this is physically possible, otherwise only in the meaningful direction; in the case of values in degrees (angles and temperatures) this means ±10°.

### LIST OF REFERENCE SIGNS

01 Conveying line

02 Gas-tight lock

03 Drying hopper

04 Gas-tight lock

05 Intermediate line

06 Reactor

07 Product gas line

08 Hot air line

09 Exhaust air line

10 External heating

BHKW Block-type thermal power station

1-8. (canceled)

9. A method for drying wood chips, wherein the wood chips are raw material for a gas-generating reactor, and a product gas of the gas-generating reactor is at least partially used in a block-type thermal power station (BHKW), comprising:
adding the wood chips to a drying hopper through a first air-tight lock;
heating air from a building or an encapsulation of the block-type thermal power station using heat radiation of the block-type thermal power station;
heating and drying the wood chips in the drying hopper using the heated air; and
discharging the dried wood chips from the drying hopper through a second air-tight lock.

10. The method of claim 9, further comprising feeding the heated air into a lower region of the drying hopper, and discharging cooled humid air from an upper region of the drying hopper.

11. The method of claim 9, wherein heating and drying the wood chips includes moving the heated air in the drying hopper counter to a flow of the wood chips.

12. A device for drying wood chips for use as a raw material in a gas-generating reactor, wherein a product gas of the gas-generating reactor is at least partially used in a block-type thermal power station (BHKW), the device comprising:
a building or encapsulation within which air is heated by heat radiation from the block-type thermal power station;
a storage container for the wood chips;
a drying hopper disposed between the storage container and the gas-generating reactor that is configured to receive wood chips from the storage container via a gas-tight entry lock and to discharge dried wood chips to the gas-generating reactor via a gas-tight exit lock;
a hot air inlet for the drying hopper that receives heated air from the building or encapsulation; and
an air outlet for the drying hopper for discharging cooled humidified air.

13. The device of claim 12, wherein the hot air inlet is disposed in a lower region of the drying hopper, and the air outlet is disposed on an upper region of the drying hopper.

14. The device of claim 12, wherein the drying hopper is disposed in direct proximity of the gas-generating reactor.

15. The device of claim 14, wherein the drying hopper is disposed above the gas-generating reactor.

16. The device of claim 15, according to claim 7, wherein the gas-tight exit lock of the drying hopper is placed on a head of the gas-generating reactor.
